(19) United States
(12) Patent Application Publication
(10) Pub. No.: US 2009/0065006 A1
(43) Pub. Date: Mar. 12, 2009

(54) Filtering respirator with rotatable filter

(76) Inventor: Keith Patterson, Alexandria, VA (US)

Correspondence Address: OLIFF & BERRIDGE, PLC, P.O. BOX 320850, ALEXANDRIA, VA, 22320-4850, US

(21) Appl. No.: 11/898,032

(22) Filed: Sep. 7, 2007

(51) Int. Cl. A62B 23/02

(52) U.S. Cl. 128/205.27

(57) ABSTRACT

A filtration system for use in a respirator includes a base member including a chamber aperture, a rotating member including a filter that rotates with respect to the base member; and a cover with an inhale entry. The inhale entry and the chamber aperture create a path through which air enters the inhale entry, passes through the filter, and exits through the inhale chamber aperture.

### CROSS REFERENCE TO RELATED APPLICATION

This application is related to co-pending U.S. patent application Ser. No. 11/730,713, filed on Apr. 3, 2007.

### BACKGROUND

The present invention relates generally to a filtering respirator.

Related art respirators have a variety of uses, including protecting a user from harmful bacteria or particles contained within unfiltered air. However, existing respirators do not adequately account for situations in which the filter degrades due to the moisture and bacteria in the air exhaled by the user into the respirator. This moisture and bacteria causes the portion of the filter closest to the user to corrode, requiring that the user receive filtered air through a corroded and degraded filter. It appears that, before the present invention, this problem, or its source, was not recognized, and/or that a suitable solution to the problem was not discovered.

Additionally, related art respirators do not take into account the amount of filter material that is wasted when a traditional stationary filter is used. Specifically, when a user of a respirator breathes through a traditional stationary filter, the portions of the filter that are in contact with the inhale and/or exhale valves are the only portions of the filter being used. This requires the user of the respirator to purchase a new filter before all of the portions of the filter material have been used.

In order to solve the above-identified problems in the related art, exemplary embodiments of the present invention allow the user of the respirator to reduce waste and make the same amount of filter material last longer for the user. Additionally, manufacturers can use less filter material when creating filters for respirators, and thereby reduce manufacturing costs.

### SUMMARY

Exemplary embodiments of a respirator comprise a breathing chamber, an inhale-only vale, an exhale-only valve and a filtration system. The inhale-only and exhale-only valves are one-way valves; the inhale-only valve only allows air to be inhaled into the respirator, and the exhale valve only allows air to be exhaled out of the respirator. Additionally, in some embodiments, a filter in the filtration system can be rotated so that an uncorroded and/or unused portion of filter can be utilized in conjunction with the exhale-only valve. Moreover, in some embodiments, a “six-shooter” type filter can be used to reduce the amount of filter material required and to ensure that filter material is not wasted, thereby extending the life of the filter.

Embodiments of the respirator can have a variety of uses. For example, the filter can be used to increase the air quality within the respirator, as air that is entering the mask is not passing through a corroded filter. Additionally, by using the “six-shooter” type filter, the use of the filter material is improved, thereby making the same amount of filter material (or a lesser amount) last longer.

These and other objects, advantages and salient features of the invention are described in or apparent from the following description of embodiments.

### BRIEF DESCRIPTION OF THE DRAWINGS

Exemplary embodiments will be described with reference to the accompanying drawings, in which like numerals represent like parts, and wherein:

FIG. 1 is a side view of an embodiment of a filtering respirator with an inhale-only valve, an exhale-only valve and a rotatable filter;

FIG. 2 is an exploded view of an embodiment of a respirator with an inhale-only valve, an exhale-only valve, and a rotatable filter;

FIG. 3 is an orthogonal view of an embodiment of a respirator with an inhale-only valve, an exhale-only valve, and a rotatable filter showing the rotation of a rotating member;

FIG. 4 is an exploded front view of an embodiment of a respirator with a “six-shooter” type filter.

FIG. 5 is a front view of an embodiment of a respirator with a “six-shooter” type filter.

FIG. 6 is an orthogonal view of an embodiment of a respirator with a rotatable cover and a wedge shaped inlet entry.

### DETAILED DESCRIPTION OF EMBODIMENTS

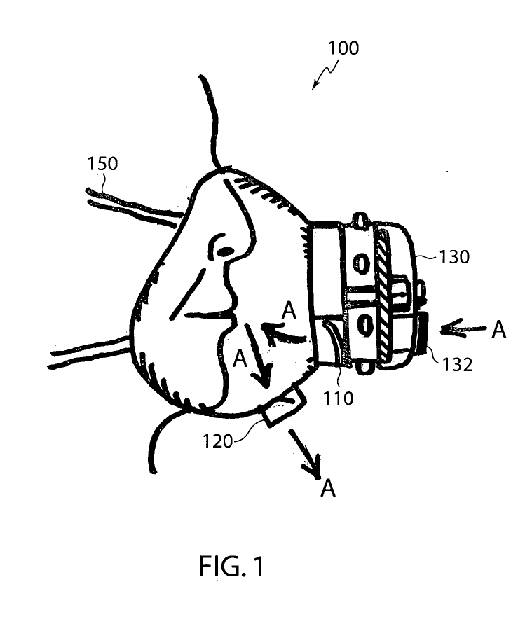

An exemplary embodiment of a respirator is shown in FIG. 1. The respirator 100 can be worn over the nose and mouth of a user and can be secured to the user by a fastener 150. While the fastener 150 in this exemplary embodiment uses two elastic straps, various fasteners can be used. For example, the respirator 100 can be secured to the user by a single tied string, or by a Velcro strap. As another example, the respirator 100 can be attached to or incorporated into a protection helmet, hood, face shield, goggles or the like.

The respirator 100 comprises an inhale-only valve 110, an exhale-only valve 120, and a filtration system 130. Air A enters the filtration system through inlet entry 132, passes through inhale-only valve 110, and enters the breathing chamber 170 of the respirator 100. The air A is then inhaled by a user and subsequently exhaled back into the breathing chamber 170 through the user's nose and/or mouth. When the air A is exhaled, it contains additional moisture and bacteria from the user. This moisture and bacteria-laden air is then passed from the breathing chamber 170 through exhale-only valve 120 without coming into contact with the filtration system 130.

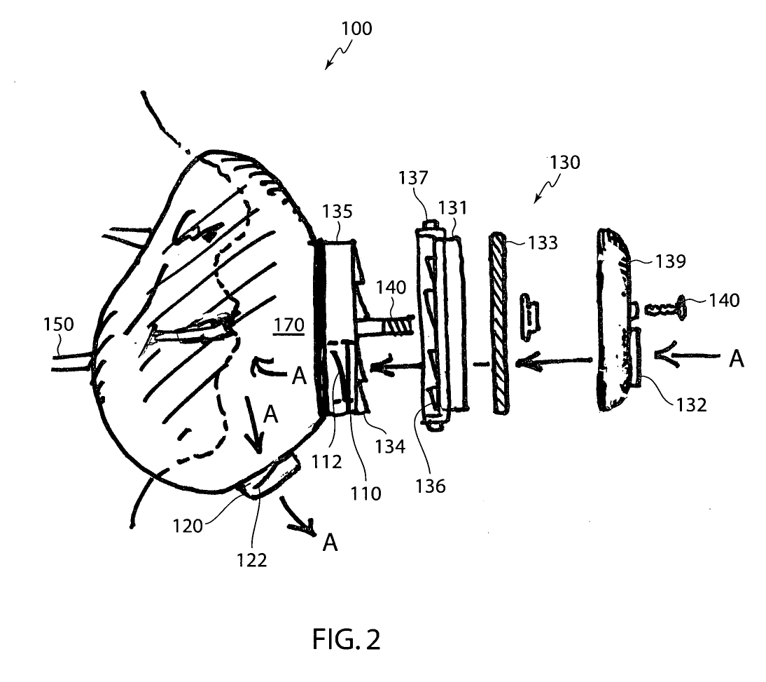

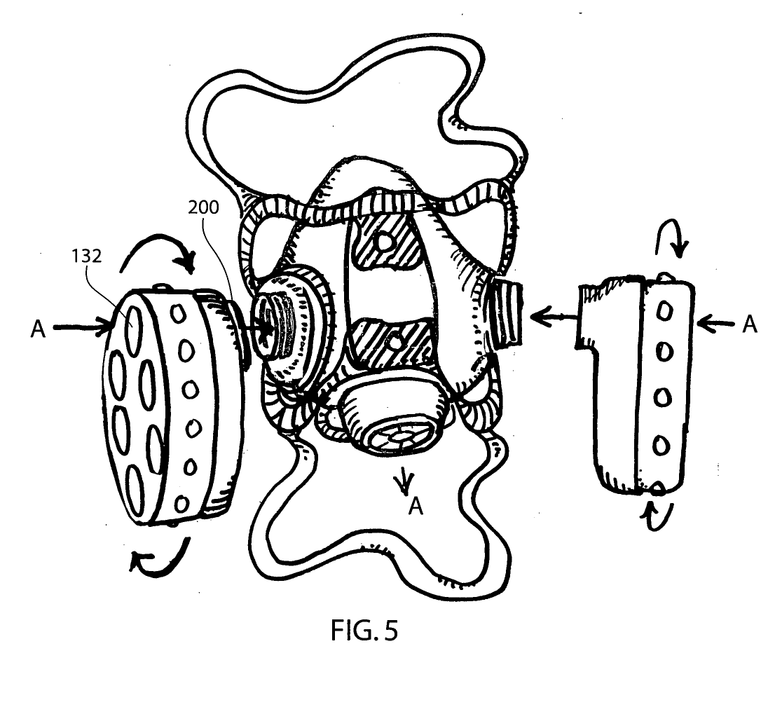

FIG. 2 shows an exploded view of an exemplary embodiment of a respirator. The inhale-only valve 110 only allows air to enter the respirator and the exhale-only valve 120 only allows air to exit the respirator. In some embodiments of the inhale-only and exhale-only valves, chamber apertures 200 (not shown in FIG. 2—see FIG. 5) are formed in the valves and/or base member where the valves and/or base member meet the breathing chamber 170 of the respirator 100. These chamber apertures 200 are covered respectively by inhale flap 112 and exhale flap 122, and may be blocked from communication with air outside of the breathing chamber when a user isn't inhaling or exhaling. Inhale flap 112 automatically opens when the user inhales, and closes when the user exhales. Exhale flap 122 automatically opens when the user exhales, and closes when the user inhales. Thus, when a user inhales, air passes through inlet entry 132, is filtered through particulate filter 133 and vapor filter 131, and passes through an aperture (not shown) after the inhale flap 112 opens. Subsequently, the user exhales, which causes inhale flap 112 to close, and exhale flap 122 to open so that air exits the breathing chamber 170.

In some embodiments, the filtration system 130 includes a base member 135, a rotating member 137, and a cover 139. The base member 135 includes the inhale-only valve 110, and contains first connecting members 134. The rotating member 137 includes a vapor filter 131 and also contains second connecting members 136. The base member 135, the rotating member 137 and the cover 139 are secured via an attachment member 140. While the attachment member 140 in this exemplary embodiment is depicted as a screw, various other types of attachment member such as a pin, a snap-lock fastener or the like can be used. Additionally, the base member 135 can also be rotatable and the rotating member 137 can either remain stationary, or rotate as well, as long as at least one of the base member 135 or the rotating member 137 is rotatable.

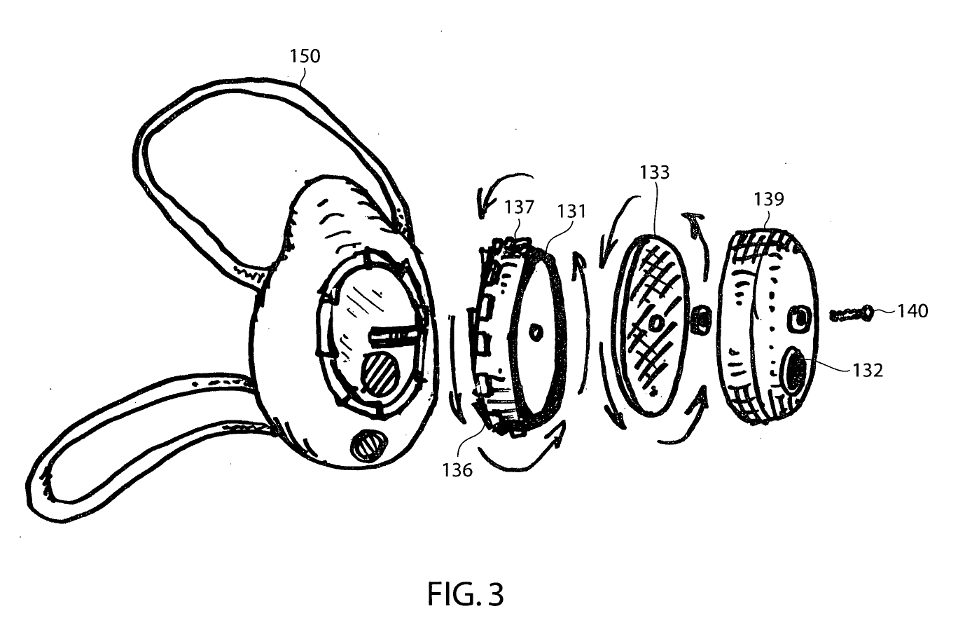

FIG. 3 shows an exploded view of the rotation of the rotating member 137. In some embodiments, the first connecting members 134 rotatably engage with the second connecting members 136 to allow the rotating member 137 to rotate with respect to the base member 135. This rotation of the rotating member 137 allows a user to inhale air through a previously unused portion of the vapor filter 131 and/or the particulate filter 133. The rotating member 137 can be rotated clockwise or counterclockwise. In some embodiments, the base member 135 can be rotated and the rotating member can remain stationary.

Further, the first connecting members 134 and the second connecting members 136 can be locked in a specific position so as to maintain the position of the rotating member 137 after the user rotates the rotating member 137 to a desired position. For example, the first connecting members 134 and the second connecting members 136 could include interlocking, relatively rotating parts sized to have friction with each other.

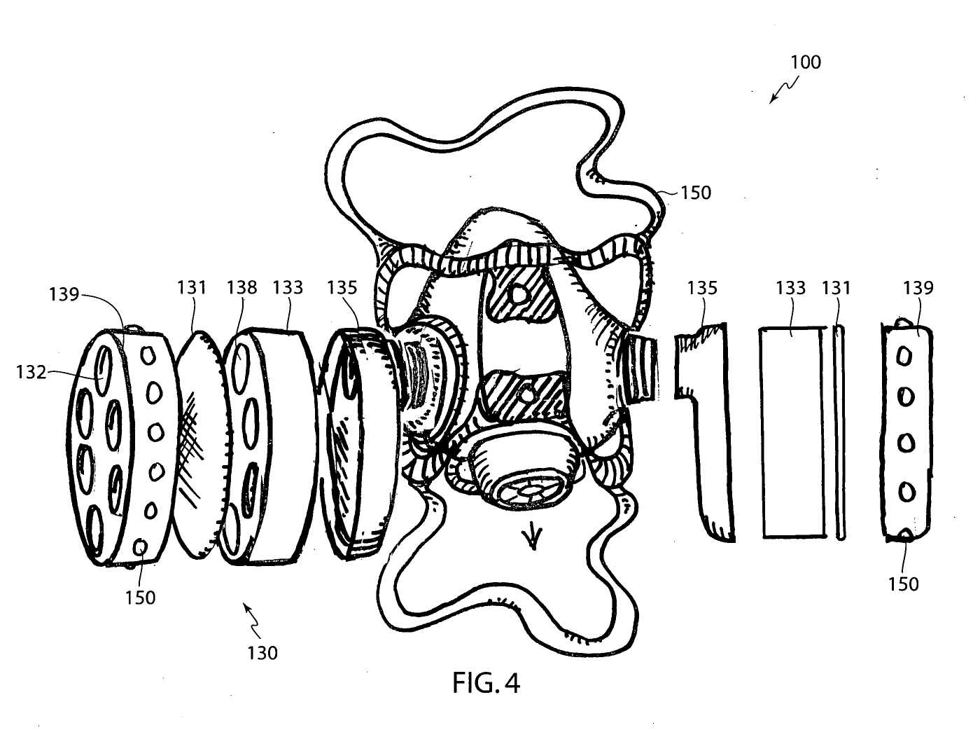

FIG. 4 shows an exploded front view of an exemplary embodiment of a respirator in which a “six-shooter” type design is used. The filtration system 130 includes a base member 135, vapor filter 131, particulate filter 133, and a cover 139. The particulate filter 133 contains one or more filtering apertures 138 containing filter material. The cover 139 contains one or more inlet entries 132 which correspond to the apertures 138 of the particulate filter 133. The vapor filter 131 and/or particulate filter 133 can be removably attached to cover 139. It will be appreciated that, in contrast to the embodiment shown in FIGS. 1-3, in which the relative position of the rotating members is continuously variable, the embodiment of FIG. 4 has discrete positions at which the apertures of the respective members align with each other.

As shown in FIG. 5, the cover 139 can rotate with respect to base member 135. Gripping knobs 160 can be provided on the cover 139 and/or base member 135 to facilitate rotation. Air A enters the filtration system through the inlet entry 132 that is in communication with aperture 200, passes through the vapor filter 131 and one of the filtering apertures 138, and enters the breathing chamber 170 of the respirator 100. While not shown in FIGS. 4 and 5, the vapor filter 131 may also have one or more corresponding filter apertures (not shown) containing filter material.

The vapor filter 131 and particulate filter 133 may be replaceable and can be made of any suitable filtering material. The filtering material may be scented or flavored, so that the user can have a pleasant experience while wearing the respirator. Additionally, or alternatively, medication can be provided on the filter so that the mask can be used to deliver medicine during a medical procedure or treatment, or to kill harmful bacteria.

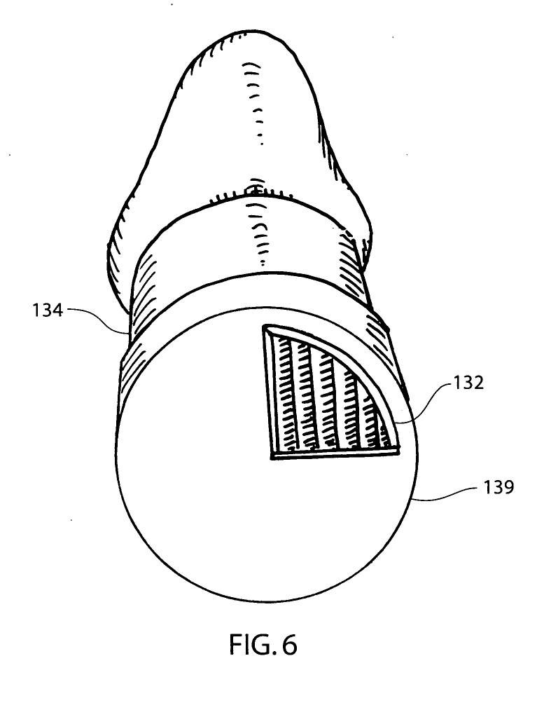

FIG. 6 is an orthogonal view of an embodiment of a respirator with a rotatable cover and a wedge shaped inlet entry. The embodiment shown in FIG. 6 includes a rotating member 137 and a cover 139 with a wedge-shaped inlet entry 132. The rotating member 137 can be rotated clockwise or counterclockwise, or can remain stationary. In addition, the cover 139 can rotate with respect to the rotating member 137 in a clockwise or counterclockwise direction.

When a user wears the respirator 100, the user can be protected from harmful bacteria or particles in the unfiltered air outside the respirator. Additionally, or alternatively, any bacteria or germs that are carried by the user can be contained by the respirator 100 by providing a filter over exhale valve 120, and therefore protect individuals around the user.

While the invention has been described in conjunction with specific embodiments, these embodiments should be viewed as illustrative and not limiting. Various changes, substitutes, improvements or the like are possible within the spirit and scope of the invention.

For example, the size, shape and location of the inhale-only vales, exhale-only valves, filtering apertures and inlet entries can be changed. For example, these valves, apertures and entries could be square, oval, or any other shape, rather than round or wedge-shaped as depicted.

As another example, the inhale and exhale valves could be located diagonally with respect to each other. Further, while an embodiment of the filter is described as a “six-shooter” type design, the number of filtering apertures is not limited to 6. For example, more or less than 6 apertures can be used. Additionally, the vapor and particle filters 131 and 133 can rotate while the cover remains stationary. Further, the “six-shooter” type particle filter 133 can be used in conjunction with a cover that only contains a single inhale entry 132.

As another example, the respirator can use different types of filters, as well as a single filter (i.e., only a vapor filter or only a particle filter) or a plurality of filters can be used.

As another example, the rotatable filter can be used with a variety of masks, such as a first responder mask. For example, the use of the rotatable filter with a first responder mask is especially helpful, as the rotatable filter increases the useful life of the filter. This, in turn, can increase the amount of time a first responder can wear the mask.

As another example, while embodiments of the filtration system have been shown as being integrally connected to a respirator, the filtration systems can be removable and replaceable.

What is claimed is:

1. A filtration system for use in a respirator, comprising:
a base member including a chamber aperture;
a rotating member including a filter that rotates with respect to the base member; and
a cover with an inhale entry,
the inhale entry and the chamber aperture creating a path through which air enters the inhale entry, passes through the filter, and exits through the inhale chamber aperture.

2. The filtration system according to claim 1, further comprising:
an attachment member that rotatably connects the cover, the rotating member and the base, and wherein
the base member includes a first connecting member,
the rotating member includes a second connecting member, and
the first connecting member rotatably engages with the second connecting member.

3. The filtration system according to claim 2, wherein the first connecting member and the second connecting member interlock to maintain the position of the rotating member after rotation.

4. The filtration system according to claim 1, wherein the base includes an inhale only valve that is positioned to be in connection with the path.

5. The filtration system according to claim 1, wherein the filter includes one or more filtering apertures.

6. The filtration system according to claim 5, wherein the cover includes one or more inhale entries corresponding to the filtering apertures.

7. A respirator, comprising:
a breathing chamber; and
the filtration system according to claim 1 in connection with the breathing chamber.
